(19) United States
(12) Patent Application Publication
(10) Pub. No.: US 2010/0242058 A1
(43) Pub. Date: Sep. 23, 2010

(54) APPARATUS FOR CLAMPING DISK OF SPINDLE MOTOR AND SPINDLE MOTOR HAVING THE SAME

(76) Inventor: Ho Eop Yoon, Gyeonggi-do (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/728,775

(22) Filed: Mar. 22, 2010

(30) Foreign Application Priority Data
Mar. 23, 2009 (KR) 10-2009-0024433

(51) Int. Cl. G11B 19/20; H02K 7/14

(52) U.S. Cl. 720/706; 310/75 R; G9B/19.027

(57) ABSTRACT

A disk clamping apparatus of a spindle motor and a spindle motor having the same are disclosed, wherein the apparatus includes a case inserted into an inner periphery of a disk for integrally rotating with a rotation shaft coupled with a rotor yoke, a plurality of claws each formed at a predetermined gap in the case, an arm mounted between the claws in the case and having a body with a slanted surface and slantedly formed at an upper surface of the disk, guide rails each mounted at both lateral surfaces of the body and a disengagement prevention rails each mounted at each guide rail and curvedly formed at the bottom surface for contacting the rotor yoke, and an elastic member elastically supporting the body by being interposed between the body and the case.

### CROSS-REFERENCE TO RELATED APPLICATION

This application claims the benefit under 35 U.S.C. §119 of Korean Application Number 10-2009-0024433, filed Mar. 23, 2009, which is hereby incorporated by reference in its entirety.

### BACKGROUND

The present disclosure relates to an apparatus for clamping disk of spindle motor and a spindle motor having the same.

In general, a spindle motor performs the function of rotating a disk at a high speed to enable an optical pickup which linearly reciprocates in an optical disk drive (ODD) to read data recorded on the disk.

A spindle motor includes a stator, a rotation shaft rotating relative to the stator, a rotor fixed to the rotation shaft and including a rotor yoke, and a disk clamping apparatus rotating with the rotation shaft and fixing the disk.

The disk clamping apparatus fixing the disk includes a disk-shaped case, a plurality of claws formed at a lateral surface of the case to contact an inner periphery of the disk and to support the disk so that a disk center can correspond with the center of the rotation shaft, an arm contacting an inner periphery upper end corner of the disk to inhibit the disk from disengaging from the case, and an elastic member mounted inside the case to elastically support the arm.

The conventional arm of the spindle motor is discrete from an upper surface of the rotor yoke such that the disk pushes up the arm when the arm and the disk are coupled. As a result, the arm suffers from a disadvantage in that a coupling force between the arm and the disk greatly decreases to cause the disk to disengage from the disk clamping apparatus even at a small shock.

### BRIEF SUMMARY

The present disclosure is to provide an apparatus for clamping disk (hereinafter called a disk clamping apparatus) of a spindle motor configured to improve a coupling structure between an arm and a disk to inhibit the disk from easily disengage from the arm.

The present disclosure is also to provide a spindle motor having a disk clamping apparatus of a spindle motor.

According to one aspect of the present disclosure, the object described above may be achieved by a disk clamping apparatus of a spindle motor which comprises: a case inserted into an inner periphery of a disk for integrally rotating with a rotation shaft coupled with a rotor yoke; a plurality of claws each formed at a predetermined gap in the case; an arm mounted between the claws in the case and having a body with a slanted surface and slantedly formed at an upper surface of the disk, guide rails each mounted at both lateral surfaces of the body and a disengagement prevention rails each mounted at each guide rail and curvedly formed at the bottom surface for contacting the rotor yoke; and an elastic member elastically supporting the body by being interposed between the body and the case.

According to another aspect of the present invention, the object described above may be achieved by a spindle motor which comprises: a stator; a rotor having a rotation shaft rotating relative to the stator and a rotor yoke coupled to the rotation shaft; a felt mounted at an upper surface of the rotor yoke to inhibit the disk from slipping; an arm having a case fixed to the rotor and inserted into an inner periphery of the disk, a plurality of claws formed at the case, a body mounted between the case and the plurality of claws and formed with a slanted surface relative to an upper surface of the disk, and a disengagement prevention rail mounted at the body to contact the rotor yoke and to inhibit the body from being lifted by the disk; and a disk clamping apparatus interposed between the body and the case to elastically support the body.

According to still another aspect of the present invention, the object described above may be achieved by a spindle motor which comprises: a rotatably mounted rotation shaft; a rotor having a rotor yoke coupled to the rotation shaft to integrally rotate with the rotation shaft and mounted with a disk; a felt, one surface of which being coupled to the rotor yoke and the other surface of which being contacted by the disk, for preventing the disk from slipping; a case, one surface of which being coupled to the rotor and a lateral surface of which being inserted by the disk; a plurality of anus linearly and rotatably mounted inside the case to enter and leave a lateral surface of the case and to inhibit the disk from being disengaged by being hitched at one distal end thereof by an inner peripheral corner of the disk; and a disk clamping apparatus having an elastic member elastically supporting the arm from a lateral outer surface of the case, wherein A/B is 1.08˜1.18, where A is a height of the arm at a rotational direction, and B is a height of the arm at a rotational direction from the other surface of the felt to a surface of the case.

### BRIEF DESCRIPTION OF DRAWINGS

FIG. 1 is a cross-sectional view of a spindle motor according to an exemplary embodiment of the present invention.

FIG. 2 is a partially exploded perspective view of a disk clamping apparatus of FIG. 1.

FIG. 3 is an enlarged view of an arm of FIG. 2.

FIGS. 4 and 5 are cross-sectional views along line “P-P” of FIG. 3 in which the disk clamping apparatus is coupled to the rotor yoke.

### DETAILED DESCRIPTION

An apparatus for clamping disk of spindle motor and a spindle motor having the same will be described in detail with reference to the accompanying drawings.

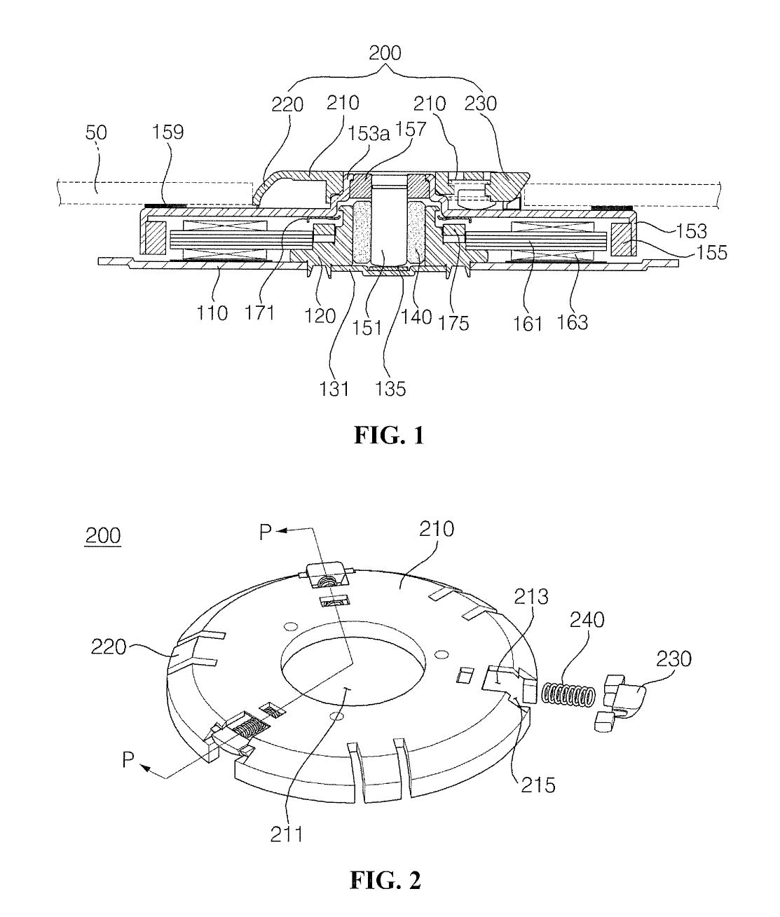

FIG. 1 is a cross-sectional view of a disk clamping apparatus and a spindle motor having the same according to an exemplary embodiment of the present invention.

Referring to FIG. 1, a bearing housing 120 is perpendicularly arranged on the base 110.

In designating a direction and a surface of constituent parts, a direction and a surface facing an upper vertical side of the base 110 are respectively called “an upper side” and “an upper surface”, while a direction and a surface facing a bottom vertical side of the base 110 are respectively called “a bottom side” and “a bottom surface”.

The cylindrical bearing housing 120 with upper and bottom surfaces opened and the bottom surface being coupled to the base 110 is provided.

The bearing housing 120 is coupled at a bottom surface to a thrust stopper 131, and the bottom surface of the bearing housing 120 is blocked by the thrust stopper 131. A bearing 140 is press-fit into the bearing housing 120 and the bearing 140 is rotatably installed with a rotor.

The periphery of the bearing housing 120 is mounted with a stator, and the stator may include a core 161 and a coil 163. The core 161 is fixed to the periphery of the bearing housing 120 and the core 61 is wound on the coil 163.

The rotor may include a rotation shaft 151 rotatably mounted in the bearing 140, a bottom-opened cylindrical rotor yoke 153 to be coupled to an upper periphery of the rotation shaft 151, and a magnet 155 coupled to an inner circumferential surface of the rotor yoke 153. The magnet 155 faces the core 161 of the stator.

In a case a current flows in the coil 163, the rotation shaft 151 is rotated by the electromagnetic force generated between the coil 163 and the magnet 155. In order to secure a strong coupling between the rotation shaft 151 and the rotor yoke 153, a coupling pipe 153a is protrusively formed at a center of the rotor yoke 15, and the coupling pipe 153a is coupled to the rotation shaft 151 via a bushing 157.

An upper edge of the rotor yoke 153 is mounted with a felt 159 for preventing a disk 50 from slipping relative to the rotor yoke 153 by being contacted with the disk 50. A bottom surface of the felt 159 is coupled to an upper surface of the rotor yoke 153, and the upper surface of the felt 159 is brought into contact with a bottom surface of the disk 50.

The rotor yoke 153 is formed with a stopper 171 hitching at an upper peripheral surface of the bearing housing 120 to inhibit the rotor from being disengaged from the bearing housing 120. The periphery of the bearing housing 120 is formed with a suction magnet 175 for preventing the rotor from lifting upwards of the bearing housing 120 when the rotor is rotated. The suction magnet 175 may be coupled to the rotor yoke 153.

The unexplained reference numeral 135 in FIG. 1 is a thrust plate configured to inhibit the thrust stopper 131 from being worn and torn.

The coupling pipe 153a of the rotor yoke 153 is coupled to a disk clamping apparatus 200 which in turn supports the disk 50 mounted on the rotor yoke 153.

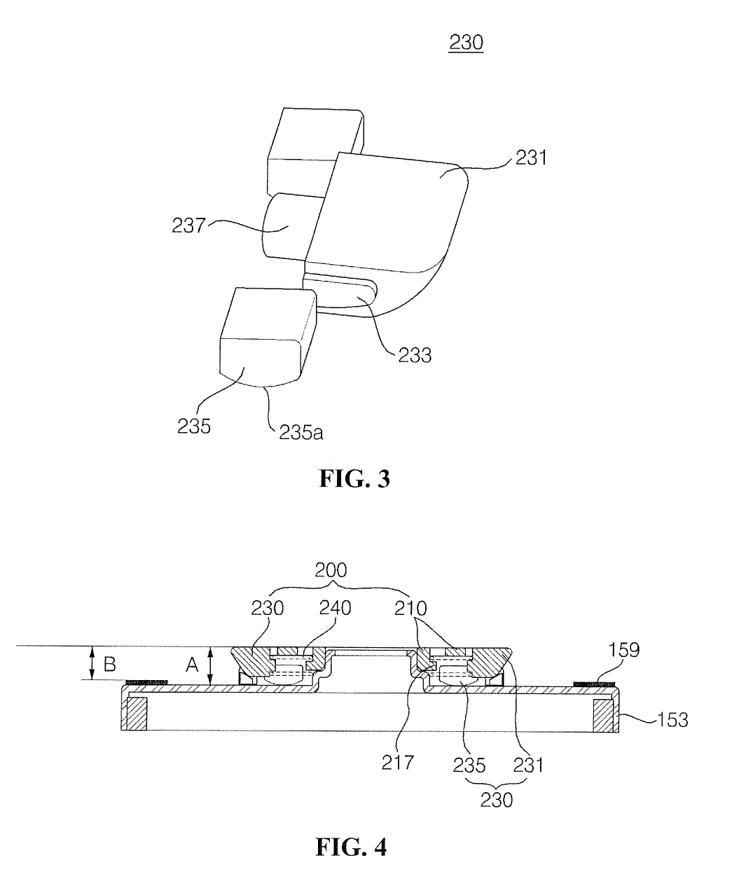

Now, the disk clamping apparatus 200 will be described in detail with reference to FIGS. 2 and 3.

FIG. 2 is a partially exploded perspective view of a disk clamping apparatus of FIG. 1, and FIG. 3 is an enlarged view of an arm of FIG. 2.

Referring to FIGS. 2 and 3, the disk clamping apparatus 200 may include a case 210, claws 220, an arm 230 and an elastic member 240.

The case 210 is provided with a bottom-opened cylindrical shape. An upper central surface of the case 210 is formed with a coupling hole 211 into which the coupling pipe 153a of the rotor yoke 153 is insertedly coupled.

The disk 50 is inserted into a lateral surface of the case 210, and the opened bottom of the case 210 faces an upper surface of the rotor yoke 153. In order to secure a stable mounting, the bottom of the case 210 is brought into contact with an upper surface of the rotor yoke 153.

The claw 220 comes in a plurality and integrally formed with the lateral surface of the case 210. Each of the plurality of claws 220 is formed at an identical space at the case 210. The claw 220 is shaped of a cantilever to fix an inner surface of the disk 50.

The claws 220, for example, are radially formed based on the center of the case 210 and are brought into contact with an inner surface of the disk 50 inserted into the case 210 to support the disk 50 so that the center of the disk 50 corresponds with the center of the rotation shaft 151.

The lateral surface of the case 210 is radially formed with a plurality of first entry holes 213 based on the center of the case 210, and a plurality of second entry holes each connected to the first entry hole 213 and having a larger size than that of the first entry hole 213.

The first entry hole 213 is formed between the claws 220, and an arm 230 (described later) performs the linear and reciprocal movements inside the first and second entry holes 213, 215.

The arm 230 may include a body 231, guide rails 233 and a disengagement prevention rail 235 and be mounted inside the case 210. One side of the body 231 is located at an outer lateral surface of the case 210, and the other side of the body 231 is mounted inside the case 210 to enter and leave the first entry hole 213.

One lateral surface facing the disk 50 in the body 231 mounted an a periphery of the case 210 includes an inclination formed at a slanted form resembling the center of the case as it faces towards the rotor yoke 153. In the present embodiment, the inclination is reversely formed relative to the upper surface of the disk 50.

In a case the disk 50 enters the case 210, an inner surface of the disk 50 is brought into contact with an upper end of the body 231 of the arm 230, whereby the body 231 is rotated clockwise and is pushed inside the case 210.

In a case the disk 50 is completely inserted into the lateral surface of the case 210 to be mounted on the rotor yoke 153, the body of the arm 230 returns to its original shape by the elastic member 240, whereby an inner upper corner of the disk 50 is hitched at the inclination of the body 231 to inhibit the disk 50 from being disengaged towards the case 210.

Each of the guide rails 233 is formed at a lateral surface of the body 231 to enter or leave the second entry hole 215. The guide rails 233 and the second entry hole 215 guide to facilitate the smooth linear movement of the arm 230.

The disengagement prevention rail 235 is extensively formed from each of the guide rails 233 to be positioned inside the case 210 as the body 231 of the arm 230 moves linearly. The bottom surface of the disengagement prevention rail 235 is brought into contact with the lateral surface of the case 210 to inhibit the arm 230 from disengaging towards the external lateral surface of the case 210 when the body 231 of the arm 230 moves towards the external side of the case 210.

Because the disengagement prevention rail 235 is protruded from a rear surface facing the inclination of the body 231 to contact the rotor yoke 153, a part of the body 231 is inhibited from being lifted by the disk 50 after the disk 50 is coupled to the inclined surface of the body 231.

An upper surface of the body 231 at the arm 230 and an upper surface of the case are arranged in parallel while the disk 50 is fixed at the body 231 of the arm 230 by the disengagement prevention rail 235.

In the present embodiment, the body 231, the guide rail 233 and the disengagement prevention rail 235 are integrally moved.

The elastic member 240 disposed inside the case 210 elastically supports the arm 230 from the lateral external surface of the case 210 in order for the arm 230 to securely support the disk 50. At this time, one side and the other side of the elastic member 240 are respectively formed with support protruders 217 (see FIG. 4) to face the other end of the body 231 and the case 210.

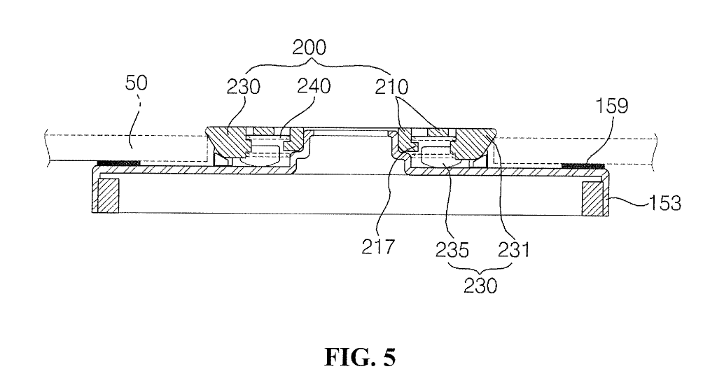

The disk clamping apparatus 200 according to the present exemplary embodiment can securely support the disk 50 and reduce an installation space as well, the detailed description of which will be provided with reference to FIGS. 4 and 5.

FIGS. 4 and 5 are cross-sectional views along line “P-P” of FIG. 3 in which the disk clamping apparatus is coupled to the rotor yoke.

Referring to FIGS. 4 and 5, assuming that A is a height of the arm 230 from bottom to top, and B is a height from an upper surface of a felt 159 to an upper surface of the case 210, A/B is 1.08˜1.18.

In the present embodiment, the height of the arm 230 from the bottom to the top is substantially the same as that from the bottom of the disengagement prevention rail 235 to the upper of the body 231.

The meaning of “A/B is 1.08˜1.18” is that the height of the arm is not relatively much lower than the height of the case 210, such that in a case the disk clamping apparatus 200 is coupled to the rotor yoke 153, the bottom surface of the arm 230 disposed inside the case 210 is brought into contact with the upper surface of the rotor yoke. As a result, in a case the disk 50 is mounted on the rotor yoke 153 to support the arm 230, the body 231 of the arm 230 contacting the inner upper corner of the disk 50 is hardly lifted by the disk 50, as illustrated in FIG. 5.

The following Table 1 shows a measurement result of a support force of the disk 50 inserted into the disk clamping apparatus 200 of the spindle motor according to the present embodiment thus configured and a disengagement distance.

TABLE 1

| | Support force | Disengagement |
|---|---|---|
| A/B | (g_{f}) | distance (mm) |
| 1.04 | 160 | 2.26 |
| 1.05 | 180 | 2.25 |
| 1.07 | 180 | 2.23 |
| 1.08 | 200 | 2.20 |
| 1.09 | 200 | 2.20 |
| 1.10 | 200 | 2.17 |
| 1.16 | 200 | 2.17 |
| 1.17 | 210 | 2.16 |
| 1.18 | 210 | 2.17 |
| 1.19 | Motion interference | |
| | generated | |
| 1.20 | Motion interference | |
| | generated | |
| 1.21 | Motion interference | |
| | generated | |

[A is a height of an arm in the direction of rotational axis]
[B is a height in the direction of rotational axis from an upper surface of a felt to an upper surface of the case]

The measurement result of the above Table <1> is an average value of support forces and disengagement distances of 10 spindle motors according to the present disclosure where A/B is 1.04˜1.21.

As shown in Table <1>, in a case where A/B is 1.041.07, the support force and the disengagement distance of disk 50 are 160˜180 g_{f} and 2.23˜2.26 mm respectively, where it could be noted that the support force is relatively weak, while the disengagement distance is relatively long.

In a case where A/B is 1.08˜1.18, the support force and the disengagement distance of disk 50 are 200˜210 g_{f} and 2.16˜2.20 mm respective, where it could be noted that the support force is relatively strong while the disengagement distance is relatively short. Furthermore, in a case where A/B is equal to or greater than 1.19, motion interference from the arm 230 can be noticed.

Therefore, A/B may be 1.08˜1.18, and more preferably A/B may be 1.16˜1.18 and an optimal A/B may be 1.10.

In the present exemplary embodiment, a bottom surface of the disengagement prevention rail 235 of the arm 230 oppositely contacting the upper surface of the rotor yoke 153 is formed with a curvature 235a protrusively formed towards the rotor yoke 153.

In the present exemplary embodiment, the bottom surface of the disengagement rail 125 and the rotor yoke 153 may be mutually line-contacted. Alternatively, the bottom surface of the disengagement prevention rail 235 may be a spherical surface protruding toward the rotor yoke 153, where the disengagement rail 125 and the rotor yoke 153 may be mutually line-contacted.

At this time, in a case a radius of curvature at a curvaceous surface 235a of the disengagement prevention rail 235 at the arm 230 is defined as R, a radius of curvature of the disengagement prevention rail 235 may be 3 mm≦R≦7 mm.

A measurement result of the support force of the disk 50 measured by changing the radius of curvature at the curvaceous surface 235a of the disengagement prevention rail 235 at the arm 230 is provide in the following Table 2, in a case where the A/B is fixed at 1.10.

TABLE 2

| Radius of curvature | Support force | |
|---|---|---|
| (mm) | (gf) | remarks |
| 10 | 180 | Motion interference |
| | | generated |
| 9 | 180 | Motion interference |
| | | generated |
| 8 | 200 | Motion interference |
| | | generated |
| 7 | 200 | — |
| 6 | 200 | — |
| 5 | 200 | — |
| 4 | 200 | — |
| 3 | 200 | — |
| 2 | 180 | — |
| 1 | 170 | — |

The measurement result of the above Table <2> is an average value measured from 10 spindle motors each having a different radius of curvature according to the present exemplary embodiment.

As depicted in Table <2>, in a case the radius of curvature is 1˜2 mm, the support force is 170˜180 g_{f}, which is relatively weak, in a case where the radius of curvature is 3˜7 mm, the support force is 200 g₁, which is relatively strong, and in a case where the radius of curvature is equal to or greater than 5 mm, motion interference from the arm 230 can be noticed. Therefore, the radius of curvature R of the disengagement prevention rail 235 is preferably in the range of 3 mm≦R≦7 mm.

Any reference in this specification to “one embodiment,” “an embodiment,” “exemplary embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with others of the embodiments.

Although embodiments have been described with reference to a number of illustrative embodiments thereof, it should be understood that numerous other modifications and embodiments can be devised by those skilled in the art that will fall within the spirit and scope of the principles of this invention. More particularly, various variations and modifications are possible in the component parts and/or arrangements of the subject combination arrangement within the scope of the disclosure, the drawing and the appended claims. In addition to variations and modifications in the component parts and/or arrangements, alternative uses will also be apparent to those skilled in the art.

What is claimed is:

1. A disk clamping apparatus of a spindle motor comprising:
a case inserted into an inner periphery of a disk for integrally rotating with a rotation shaft coupled with a rotor yoke;
a plurality of claws each formed at a predetermined gap in the case; an arm mounted between the claws in the case and having a body with a slanted surface and slantedly formed at an upper surface of the disk, guide rails each mounted at both lateral surfaces of the body and a disengagement prevention rails each mounted at each guide rail and curvedly formed at the bottom surface for contacting the rotor yoke; and
an elastic member elastically supporting the body by being interposed between the body and the case.

2. The apparatus of claim 1, wherein a radius of curvature of the disengagement prevention rail is in the range of 3 mm≦R≦7 mm, if the radius of curvature at a curvaceous surface of the disengagement prevention rail at the arm is defined as R.

3. A spindle motor having a disk clamping apparatus comprising:
a stator; a rotor having a rotation shaft rotating relative to the stator and a rotor yoke coupled to the rotation shaft;
a felt mounted at an upper surface of the rotor yoke to inhibit the disk from slipping;
an arm having a case fixed to the rotor and inserted into an inner periphery of the disk, a plurality of claws formed at the case, a body mounted between the case and the plurality of claws and formed with a slanted surface relative to an upper surface of the disk, and a disengagement prevention rail mounted at the body to contact the rotor yoke and to inhibit the body from being lifted by the disk; and
a disk clamping apparatus interposed between the body and the case to elastically support the body.

4. The spindle motor of claim 3, wherein A/B is 1.08˜1.18, if A is a height between an upper surface of the body of arm and an upper surface of the rotor yoke, and B is a height between an upper surface of the felt and an upper surface of the body.

5. The spindle motor of claim 3, wherein A/B is 1.16˜1.18, if A is a height between an upper surface of the body of arm and an upper surface of the rotor yoke, and B is a height between an upper surface of the felt and an upper surface of the body.

6. The spindle motor of claim 3, wherein a bottom surface of the disengagement prevention rail and the rotor yoke is mutually line-contacted.

7. The spindle motor of claim 6, wherein a bottom surface of the disengagement prevention rail contacting the rotor yoke is curved.

8. The spindle motor of claim 7, wherein a radius of curvature of the disengagement prevention rail is in the range of 3 mm≦R≦7 mm, if the radius of curvature at a curvaceous surface of the disengagement prevention rail at the arm is defined as R.

9. The spindle motor of claim 7, wherein the bottom surface of the disengagement prevention rail is a spherical surface spot-contacted to the rotor yoke.

10. The spindle motor of claim 3, wherein the arm includes a guide rail interposed between both lateral surfaces of the body and the disengagement prevention rail.

11. A spindle motor which comprising:
a rotatably mounted rotation shaft; a rotor having a rotor yoke coupled to the rotation shaft to integrally rotate with the rotation shaft and mounted with a disk;
a felt, one surface of which being coupled to the rotor yoke and the other surface of which being contacted by the disk, for inhibiting the disk from slipping; a case, one surface of which being coupled to the rotor and a lateral surface of which being inserted by the disk;
a plurality of arms linearly and rotatably mounted inside the case to enter and leave a lateral surface of the case and to inhibit the disk from being disengaged by being hitched at one distal end thereof by an inner peripheral corner of the disk; and
a disk clamping apparatus having an elastic member elastically supporting the arm from a lateral outer surface of the case,
wherein A/B is 1.08˜1.18, if A is a height of the arm at a rotational direction, and B is a height of the arm at a rotational direction from the other surface of the felt to a surface of the case.

12. The spindle motor of claim 11, wherein the bottom surface of the arm facing the rotor yoke contacts the rotor yoke.

13. The spindle motor of claim 11, wherein the bottom surface of the arm facing the rotor yoke is a spherical surface protruding toward the rotor yoke.

14. The spindle motor of claim 11, wherein a radius of curvature of the spherical surface of the arm is in the range of 3 mm≦R≦7 mm, if the radius of curvature at a spherical surface of the arm is defined as R.

15. The spindle motor of claim 11, wherein the spindle motor comprises: a body in which one lateral end of the arm is positioned at an external lateral side of the case to support the disk while the other end side is positioned inside the case; guide rails each formed at a lateral surface of the body to guide the movement of the body; and a disengagement prevention rail extensively formed from each guide rail to be positioned at an inner surface of the case and to contact the lateral surface of the case and to inhibit the body from disengaging toward the lateral external side of the case.

16. The spindle motor of claim 15, wherein an upper surface of the body at the arm and an upper surface of the case are arranged in parallel while the disk is fixed at the body of the arm by the disengagement prevention rail.
